(19) United States
(12) Patent Application Publication
(10) Pub. No.: US 2023/0048980 A1
(43) Pub. Date: Feb. 16, 2023

(54) Stack-It Bracket

(71) Applicant: James Tiner, Reno, NV (US)

(72) Inventor: James Tiner, Reno, NV (US)

(21) Appl. No.: 17/401,274

(22) Filed: Aug. 12, 2021

(51) Int. Cl. E04B 1/26

(52) U.S. Cl. CPC E04B 1/2608

(57) ABSTRACT

An article of manufacture for providing brackets for use in a moving and self-storage system is disclosed. The bracket has one or more plates coupled together to for a flat surface for attaching to items used to construct storage objects, a plurality of through holes in the plates allowing attachment mechanisms to secure the plates to the items used to construct storage object, and two or more orthogonal plate members extending outward from a bottom edge of the one or more plates, the orthogonal plate members being configured to engage a bottom surface of the items used to construct storage objects when the one or more plates are attached to sides of the items used to construct storage objects.

### TECHNICAL FIELD

This application relates in general to an article of manufacture for providing a construction aid, and more specifically, to an article of manufacture providing brackets for use in a moving and self-storage system.

### BACKGROUND

Moving vans, PODS™, and cargo containers are difficult to load efficiently due to the height of the storage space. Moving Platforms provide a means of allowing improved placement of items in these containers by converting the space into two levels. Additionally, there are many situations where an available storage space can be better organized and configured to facilitate efficient storage. Shelving units, tables, platforms, etc. can be installed in a storage space to enable additional storage of items, placement of organizers, drawers, etc. This in turn facilitates easier placement and retrieval of items in the space. Unfortunately, no two storage spaces are alike, and storage may be required in a range of situations, such as sheds, attics, vehicles, etc. Because of this variety, it can be difficult to provide a cost-effective, one- size-fits-all solution.

Therefore, a need exists for an article of manufacture for providing brackets allowing unlimited custom sizes of fixtures for use in a moving and self-storage system. The present invention attempts to address the limitations and deficiencies in prior solutions according to the principles and example embodiments disclosed herein.

### SUMMARY

In accordance with the present invention, the above and other problems are solved by providing an article of manufacture for brackets for use in a self-storage system according to the principles and example embodiments disclosed herein.

In one embodiment, the present invention the bracket has one or more plates coupled together to for a flat surface for attaching to items used to construct storage objects, a plurality of through holes in the plates allowing attachment mechanisms to secure the plates to the items used to construct storage object, and two or more orthogonal plate members extending outward from a bottom edge of the one or more plates, the orthogonal plate members being configured to engage, support, and align a bottom surface of the items used to construct storage objects when the one or more plates are attached to sides of the items used to construct storage objects.

In another aspect of the present invention, the one or more plates comprise a single broad plate member having two orthogonal plate members coupled to a bottom edge of the single plate member about each end of the single plate member.

In another aspect of the present invention, the plurality of through holes are arranged in a plurality of rows of parallel holes spaced across the single broad plate.

In another aspect of the present invention, the plurality of through holes are arranged in a plurality of rows of parallel holes spaced across the single broad member and a plurality of rows of parallel holes spaced along the single broad member perpendicular narrow member.

In another aspect of the present invention, the one or more plates comprise a single broad member having two orthogonal plate members coupled to a bottom edge of the single broad member about each end of the single plate member and a perpendicular narrow member extending downward from the edge of the single broad member between the two orthogonal plate members.

In another aspect of the present invention, the plurality of through holes are arranged in a plurality of rows of parallel holes spaced across the single broad member and a plurality of rows of parallel holes spaced along the single broad member perpendicular narrow member.

In another aspect of the present invention, the single broad member and the perpendicular narrow member having a continuous bend running vertically from a top edge of the single broad member to a bottom edge of the perpendicular narrow member about the center forming a corner bracket with identical mirrored side.

In another aspect of the present invention, the plurality of through holes are arranged in a plurality of rows of parallel holes spaced across the single broad member and a plurality of rows of parallel holes spaced along the single broad member perpendicular narrow member, a number of the plurality of through holes are identical on each side of the continuous bend.

In another aspect of the present invention, the bracket is made of stainless steel.

In another aspect of the present invention, the attachment mechanisms comprise wood screws, nails, and fasteners.

In one embodiment, the present invention is an article of manufacture for providing a corner bracket for use in a moving and self-storage system.

In another embodiment, the present invention is an article of manufacture for providing an intermediate leg bracket for use in a self-storage system.

In yet another embodiment, the present invention is an article of manufacture for providing a backstop bracket for use in a self-storage system.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

Referring now to the drawings in which like reference numbers represent corresponding parts throughout:

FIGS. 1a-b illustrate example embodiments of an article of manufacture for providing a comer bracket and a stacked comer bracket for a moving and self-storage system according to the present invention.

FIGS. 2a-b illustrate top and side views of an article of manufacture for providing an intermediate leg bracket in a self-storage system according to the present invention.

FIGS. 3a-b illustrates an article of manufacture for providing an intermediate leg shelf bracket in a self-storage system according to the present invention.

FIGS. 4a-b illustrate use of an article of manufacture for a clothes hanging rod bracket in a self-storage system according to the present invention.

FIGS. 5a-d illustrate use of the comer brackets using the spacer blocks to position the bracket according to the present invention.

FIGS. 6a-b illustrate embodiments of use of intermediate leg brackets and stacked comer brackets according to the present invention.

FIG. 7 illustrates an embodiment of comer brackets according to the present invention.

FIGS. 8a-b illustrate embodiments of use of clothes hanging rod brackets according to the present invention.

FIGS. 9a-c illustrate use an article of manufacture for providing a various brackets for a self-storage system according to the present invention.

### DETAILED DESCRIPTION

This application relates in general to an article of manufacture for providing a construction aid, and more specifically, to an article of manufacture for providing brackets for use in a moving and self-storage system according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps, or components, but do not preclude the presence or addition of one or more other features, steps, or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

The terms “individual” and “user” refer to an entity, e.g., a human, using an article of manufacture for providing a bracket for use in a self-storage system associated with the invention. The term user herein refers to one or more users.

The term “invention” or “present invention” refers to the invention being applied for via the patent application with the title “Stack-It Bracket.” Invention may be used interchangeably with bracket.

In general, the present disclosure relates an article of manufacture for providing a bracket for use in a moving and self-storage system according to the present invention. To better understand the present invention, FIGS. la-b illustrate example embodiments of an article of manufacture for providing a corner bracket and a stacked corner bracket for a moving and self-storage system according to the present invention. A self-storage solution that can be configured for a range of storage spaces of varying sizes and shapes will be described herein. The self-storage solution has the advantage of being easily configurable with a minimal set of operations and principles. The basis of the self-storage system is bracket members that enable convenient, adaptable configuration and assembly of frame members to form a structural support. Additionally, the use of the brackets of the present invention as disclosed hereon, permits storage objects constructed using these brackets to be structurally efficient with aesthetically smooth surfaces.

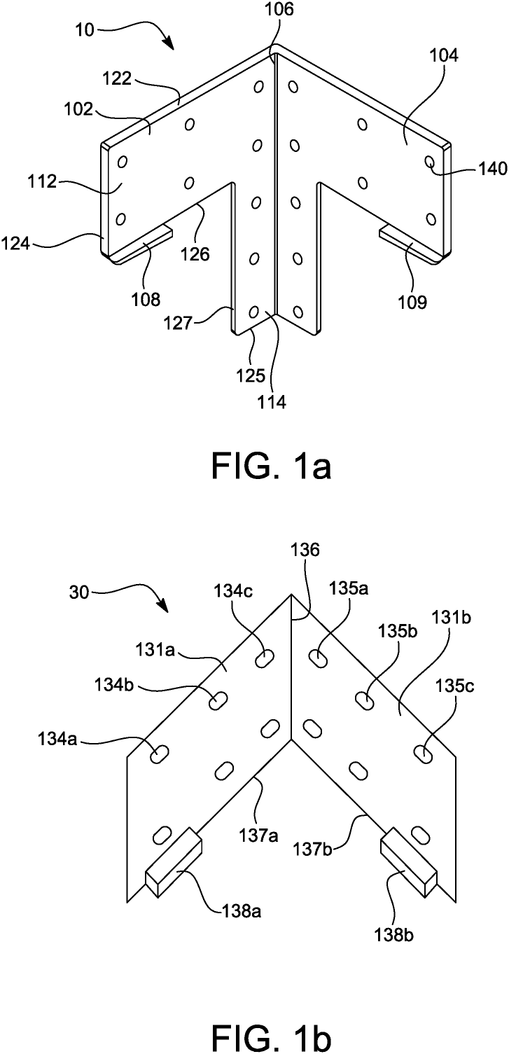

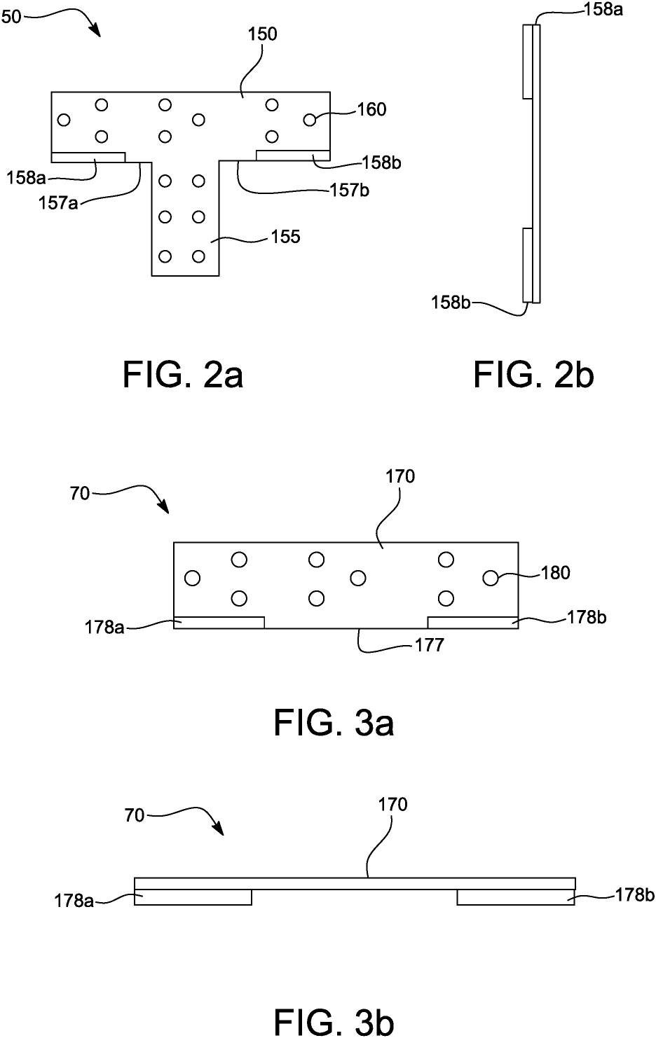

A first bracket member is shown generally at 10 in FIG. 1a. A stacked corner bracket member IO is a corner bracket that allows orthogonal frame members to be selectively connected to each other to create a stacked platform support. A shelf support corner bracket member is shown generally at 30 in FIGS. 2a-b. An intermediate leg bracket member 50 is a flat, T-shaped bracket that allows longitudinal frame members to be selectively connected to each other to create a platform support. A third bracket member is shown generally as an intermediateshelf bracket 70 in FIGS. 3a-b. The intermediate shelf bracket 70 is a flat, broad-shaped shelf bracket that allows longitudinal frame members to be selectively connected to an orthogonal member to create a platform shelf support.

The corner bracket 10 has three orthogonal elements that facilitate the securing of a framework as shown in FIG. Fig, 1. The corner bracket 10 may be formed from sheet metal by cutting the sheet metal to a required shape and then bending the metal to form an angle bracket having a first plate 102 joined to a second plate 104 at a right-angle bend 106. Plates 102, 104 are symmetrical and form primary orthogonal elements of the corner bracket 10. The description to follow will primarily describe the plate 102, but similar description applies to plate 104.

As stated, the sheet metal may be cut to a shape that forms specific shapes for the plates 102, 104. Each plate 102, 104 includes a broad section 112 and a narrow section 114. The broad section 112 extends laterally from the angle 106 for a distance. The broad section 112 has a top edge 122, end edge 124 and bottom edge 126. In one embodiment, the width or distance of the broad section 112, i.e., the distance of the top edge 122, is 6.11 inches but may be an arbitrary length. The height of the broad section 112, i.e., the distance of the end edge 124, may be approximately 3.25 inches and is selected to substantially match a first dimension of the timber frame members that will be used in the framework as will be described in more detail below.

The narrow section 114 extends perpendicular from the bottom edge 126 of the broad section for a distance. The narrow section 114 has a side edge 132 and end edge 134. In one embodiment, the height of the narrow section 114, i.e., the distance of the side edge 132 is 4.75 inches but may be an arbitrary length. The width of the narrow section 114, i.e., the distance of the end edge 134 may be 1.74 inches and is chosen to substantially match a second dimension of the timber that will be used in the framework as will be described in more detail below.

Extending inward from the bottom edge 126 of the broad section 112 adjacent to the end edge 124 is a third orthogonal plate member 108 that provides a support, or guide, for timber framework as will be described in more detail below. In one embodiment, the plate member 108 extends inward (orthogonal) of the broad section 112 for approximately 0.5 inch, though this distance may be arbitrary. The plate member 108 may extend approximately 2 inches along the bottom edge 126, though this distance may be arbitrary.

The corner bracket IO may be used to conveniently assemble orthogonal frame members, e.g., timber frame members as will be described herein. The plates 102, 104 are therefore provided with an array of holes 140 for allowing fixings such as screws to connect the bracket to the frame members. The array of holes 140 may be arranged using any pattern with a preferred embodiment having the array of holes 140 distributed about the broad section 112 and the narrow section 114 of the corner bracket 10.

FIG. 1b shows a corner shelf bracket according to the present invention. A corner bracket 30 is shown in FIG. 1b having a pair of broad members 131a-b arranged about a corner bend 136 in a similar manner to the corner bracket 10 of FIG. 1a. The corner bracket 30 has a pair of orthogonal plate members 138a-b extending outward from the broad members 131a-b along a bottom edge 137a-b. A set of holes 134a-c, 135a-c are positioned about the pair of broad members 131a-b to permit the corner bracket 30 to be mounted about a corner. As with the corner bracket 10, the size of the pair of broad members 131a-b, the outward extension of the orthogonal pate members 138a-b, and the number and arrangement of the holes 134a-c, 135a-c may vary as needed in the various embodiments of the corner bracket 30.

FIGS. 2a-b illustrate top and side views of an article of manufacture for providing an intermediate leg bracket in a self-storage system according to the present invention. A front view of an intermediate leg bracket 50 is shown in FIG. 2a and a top view of the intermediate leg bracket is shown in FIG. 2b. The intermediate leg bracket 50 comprises a bracket similar to a corner bracket IO without the right-angle bend I06 about a vertical center line. The intermediate leg bracket 50 may be formed from sheet metal by cutting the sheet metal to a required shape. The intermediate leg bracket 50 comprises a single broad plate member 150 and a perpendicular narrow member 155 extending downward from a bottom edge 157a-b of the single broad plate member 150. The intermediate leg bracket 50 also comprises a pair of orthogonal plate members 158a-b extending inward from the bottom edge of the broad plate member.

The single broad plate member 150 and the perpendicular narrow member 155, are provided with an array of holes 160 for allowing fixings such as screws to connect the bracket to the frame members. As with the comer bracket 10 of FIG. 1, the array of holes 160 may be arranged using any pattern with a preferred embodiment having the array of holes 160 distributed about the single broad plate member 150 and the perpendicular narrow member 155 of the intermediate leg bracket 50. Similar to the comer bracket 10, the intermediate leg bracket 50 may be sized chosen to substantially match a second dimension of the timber that will be used in the framework.

The benefit of this bracket design is it allows the leg to extend full height from under (stacked) the top member and pass through the shelf to the floor, providing the best structural strength possible for the tabletop or platform, while maintaining the smooth outer and inner surfaces for best esthetic appearance.

FIGS. 3a-b illustrates an article of manufacture for providing an intermediate leg shelf bracket in a self-storage system according to the present invention. A front view of an intermediate shelf bracket 70 is shown in FIG. 3a and a top view of the intermediate shelf bracket 70 is shown in FIG. 3b. The intermediate shelf bracket 70 comprises a bracket similar to the intermediate leg bracket’s 50 perpendicular narrow member 155. The intermediate shelf bracket 70 may be formed from sheet metal by cutting the sheet metal to a required shape. The intermediate shelf bracket 70 comprises a single broad plate member 170. The intermediate shelf bracket 70 also comprises a pair of orthogonal plate members 178a-b extending inward from the bottom edge 177 of the broad single broad plate member 170.

The single broad plate member 170 is provided with an array of holes 180 for allowing fixings such as screws to connect the bracket to the frame members. As with the comer bracket 10 of FIG. 1, the array of holes 180 may be arranged using any pattern with a preferred embodiment having the array of holes 180 distributed about the single broad plate member 170 of the intermediate shelf bracket 70. Similar to the comer bracket 10, the intermediate shelf bracket 70 may be sized chosen to substantially match a second dimension of the timber that will be used in the framework.

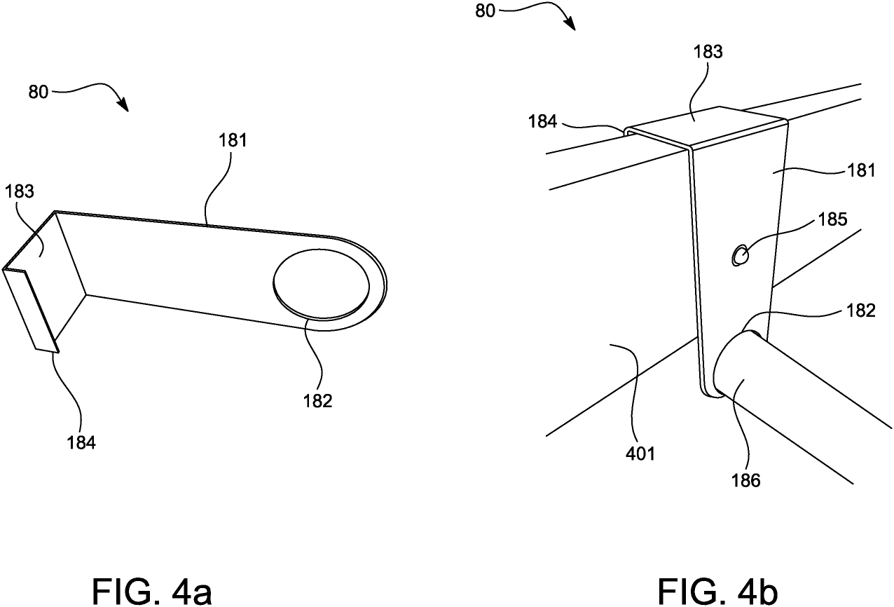

FIGS. 4a-b illustrate use of an article of manufacture for a clothes hanging rod bracket in a self-storage system according to the present invention. The clothes hanging rod bracket 80, as shown in FIG. 4a, comprises a top member 183 having a retention tab member 184 and a rod holding member 181 extending downward on opposing sides of the top member 183. The top member 183 is sized to match a width of a supporting frame member 401 to permit the retention tab member 184 and the rod holding member 181 to rest against the vertical sides of the supporting frame member 401 as shown in FIG. 4b.

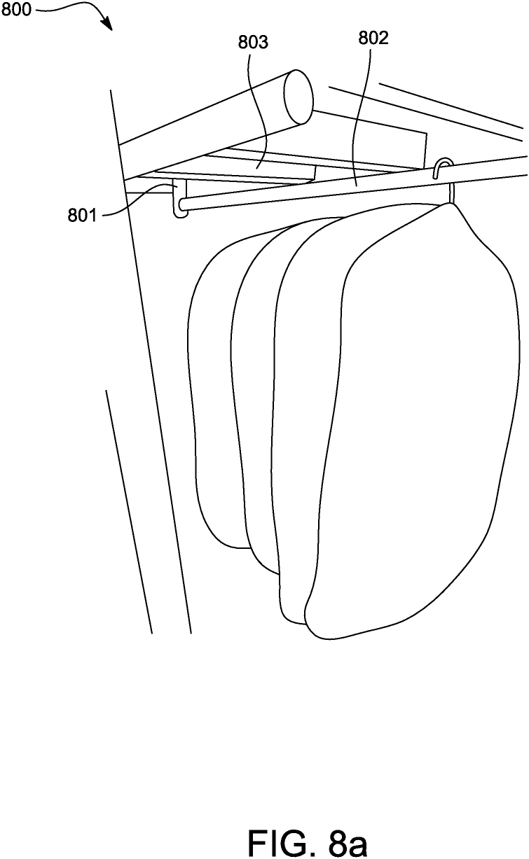

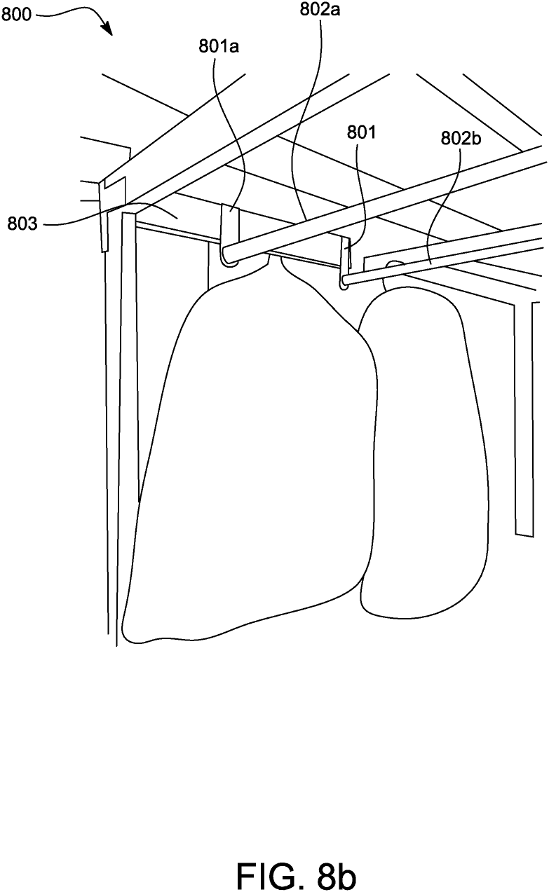

The rod holding member 181 includes a rod insertion hole 182 for supporting a clothes rod 186 that is oriented between a pair of supporting frame members 401 as shown in detail with reference to FIGS. 8a-b below. A securing screw 185 through the rod holding member 181 secures the clothes hanging rod bracket 80 in place. The rod insertion hole 182 is sized to match the diameter of the supporting a clothes rod 186 and may be made of different diameters.

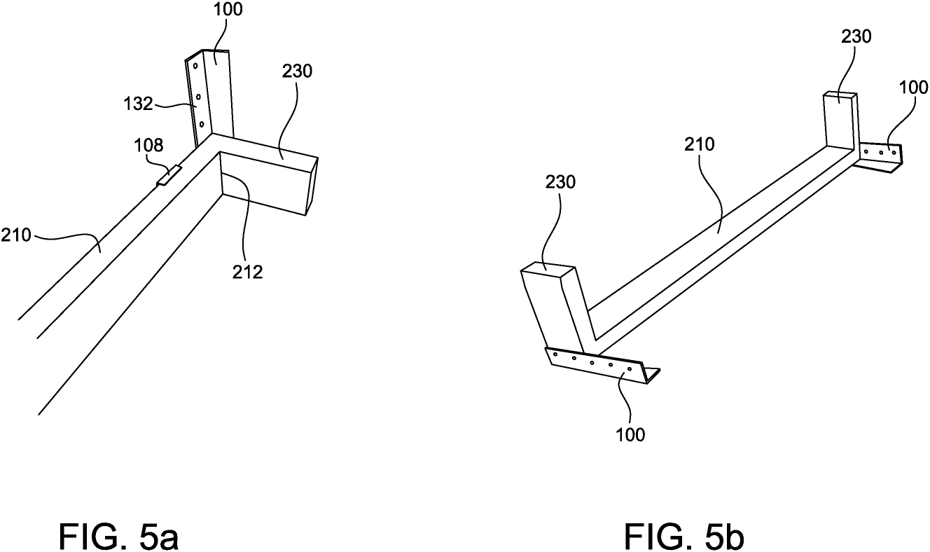

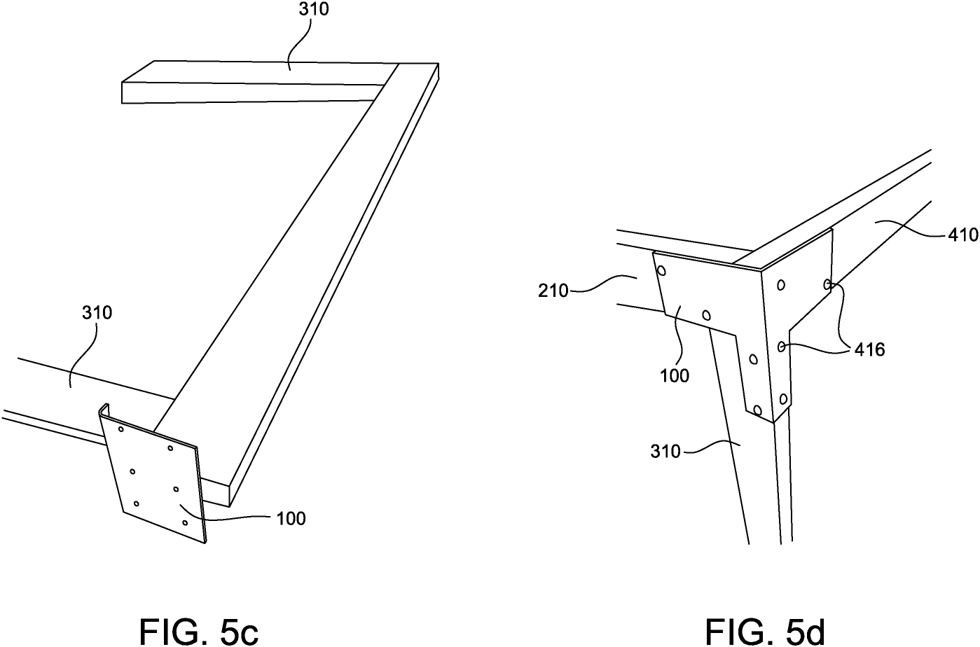

FIGS. 5a-d illustrate use of an article of manufacture for a comer bracket for use in a self-storage system according to the present invention. Fig. Sa shows an initial stage of a framework assembly. A first lateral frame member 210 is laid on a support platform and the bracket 100 is placed so that the orthogonal plate 108 rests on an under edge of the frame member 210 (shown inverted in Fig. Sa). The inner face of the broad section lies adjacent to the outer face of the frame member 210. The end edge 212 of the frame member 210 is aligned with the side edge 132 of the narrow section of the plate. To facilitate this latter alignment, a spacer block 230 may optionally be temporarily installed with the end face of the frame member 210 abutting the spacer block 230. Screws may then be used to secure the plate to the frame member 210.

Fig. Sb shows a second bracket 100 installed at the opposite end of the frame member 210. At this stage, spacer blocks 230 remain in place at each of the brackets 100. Additional frame members may be attached orthogonally to the frame support member 210 and coupled to the pair of brackets 100. The spacer blocks are temporarily placed to position the brackets for attachment, then the spacers may be removed.

In Fig. Sc, vertical frame members 310 are installed along the narrow sections of the plates with the end edges of the vertical frame members 310 abutting the under edge of the frame member 210. Screws may be inserted through the holes in the narrow section of the plates to fix the vertical frame members 310 to the bracket. In Fig. Sc, the spacer blocks have been removed. The gap left by the spacer blocks allows additional lateral frame members to be inserted and fixed to the bracket with screws.

Fig. Sd shows the bracket 100 fully installed to three orthogonal frame members. Screws 416 secure the bracket 100 to each of the frame members 210, 310, 410. It can be seen that the widths and heights of the bracket portions are matched to the dimensions of the frame members to make installing the bracket straightforward with simple alignment of edges. These brackets, when used together, permit the frame members 210, 410 to be placed (stacked) on top of member 310. Additionally, the pair of orthogonal plate members 108 and 109 (as shown in FIG. 1a) engage a bottom edge of an additional lateral member 210 and 410 to assist in holding the additional lateral member 210 in place.

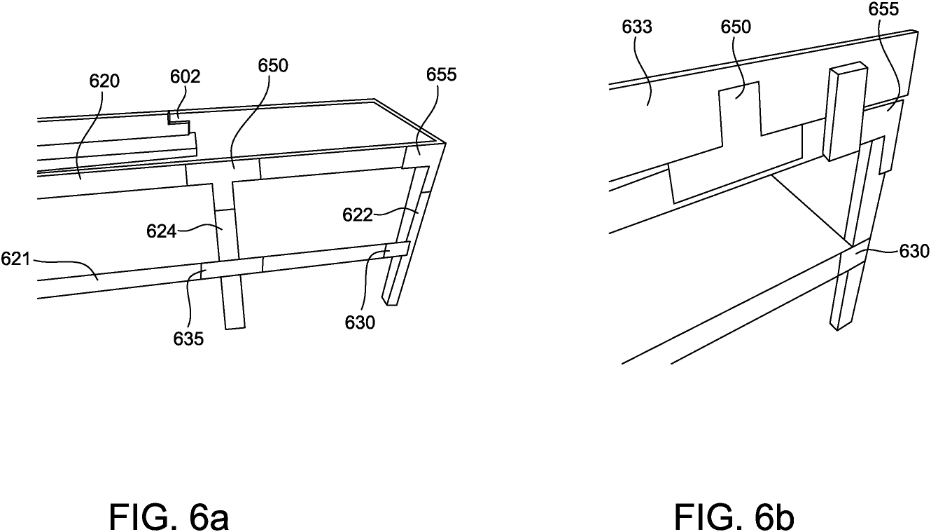

FIGS. 6a-b illustrate embodiments of intermediate leg brackets and stacked comer brackets according to the present invention. FIG. 6a and FIG. 6b show an intermediate leg bracket 650 being coupled to a connecting joint between a horizontal lumber member 620 and a perpendicular vertical lumber member 624. This construction allows the member 620 to be placed on top of member 624 in a stacked configuration for greatest structural strength. The intermediate leg bracket 650 has a pair of orthogonal plate members 158a-b (not visible) abutting a bottom edge of the horizontal lumber member 620 to assist in aligning the orientation between the horizontal lumber member 620 and the perpendicular vertical lumber member 624.

FIG. 6a and FIG. 6b also show a comer bracket 630 and an intermediate shelf bracket 635 to support additional horizontal lumber members and additional vertical lumber member. The vertical lumber member extends through intermediate shelf bracket 635. A shelf support horizontal members terminate at the leg and are supported by the tab and screws of 635. A stacked comer bracket 655 is shown creating a top comer for the work bench 602 made using these brackets. In a separate configuration, the intermediate leg bracket 650, shown in FIG. 6b, is oriented upward as compared to downward as shown in FIG. 6a, to support a backstop for the work top. In FIG. 6a, the intermediate leg bracket 650 is coupled to the vertical lumber member 624 and the intermediate leg bracket 650 in FIG. 6b is supporting a backstop surface 633 to the worktable 602.

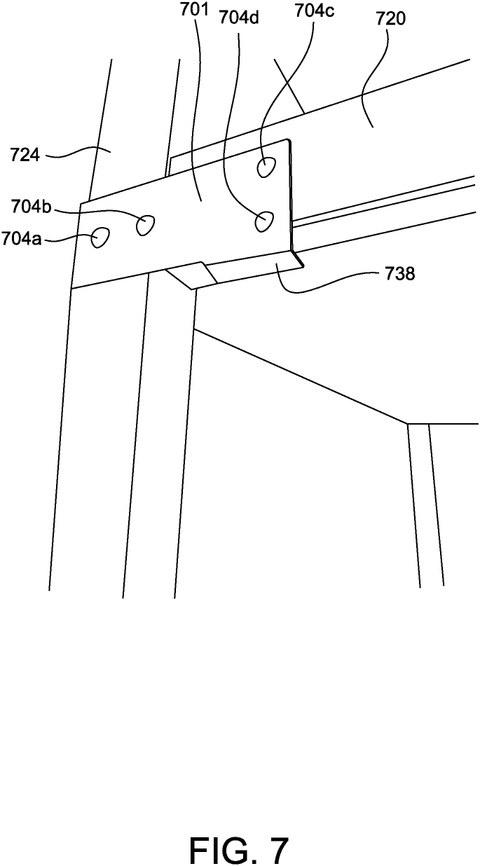

FIG. 7 illustrates an embodiment of a comer brackets according to the present invention. FIG. 7 shows an underside of an installed comer bracket 701 connecting a horizonal lumber member 720 and a vertical lumber member 724. One 738b of the pair of orthogonal plate members 738a-b is visible under the horizontal lumber member 720 to support its position when installed. The comer bracket 701 is secured to the horizonal lumber member 720 and the vertical lumber member 724 by a set of securing screws 704a-d.

FIGS. 8a-b illustrate use of an article of manufacture for a clothes hanging rod bracket 801 for use in a self-storage system according to the present invention. FIG. 8a shows a support structure 800 having a clothes hanging rod bracket 801 coupled to a horizontal frame member 803 to support a clothes hanging rod 802. FIG. 8b shows a pair of clothes hanging rod brackets 801a-b coupled to a horizontal frame member 803 to support a pair of clothes hanging rods 802a-b.

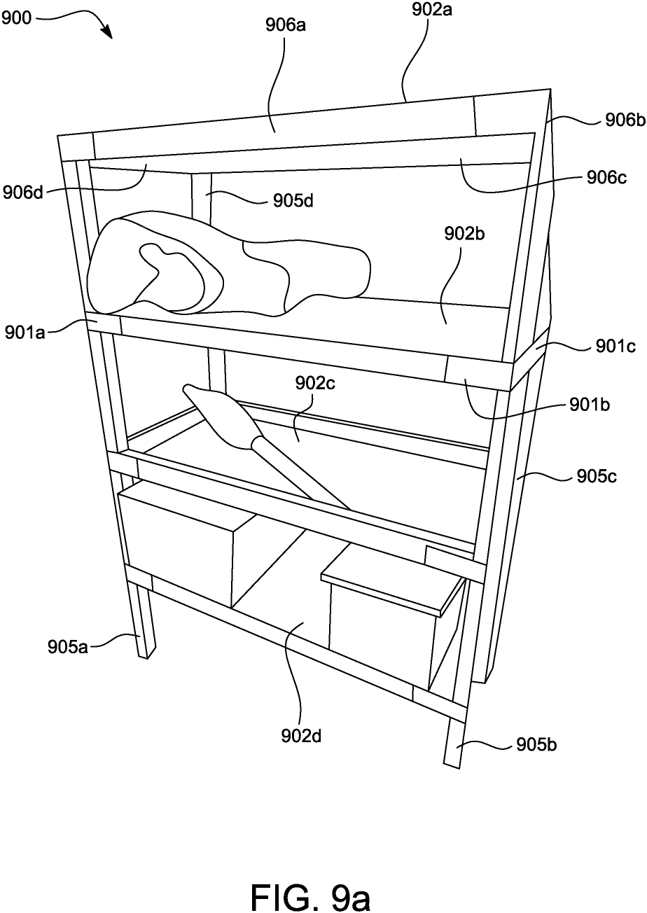

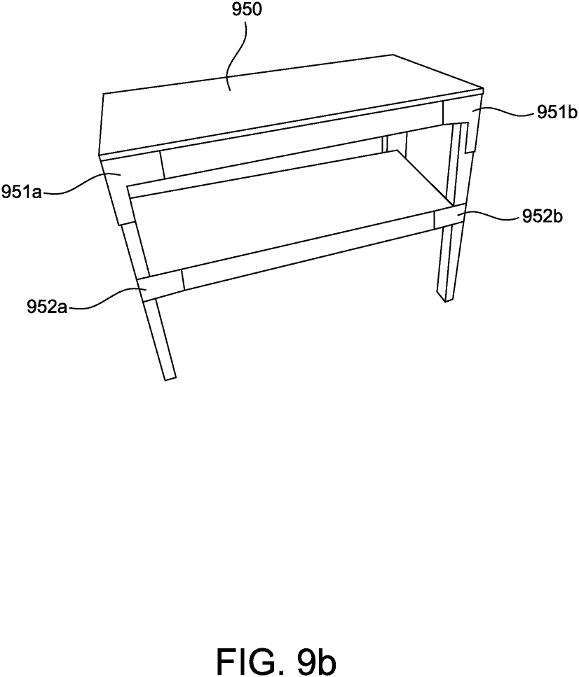

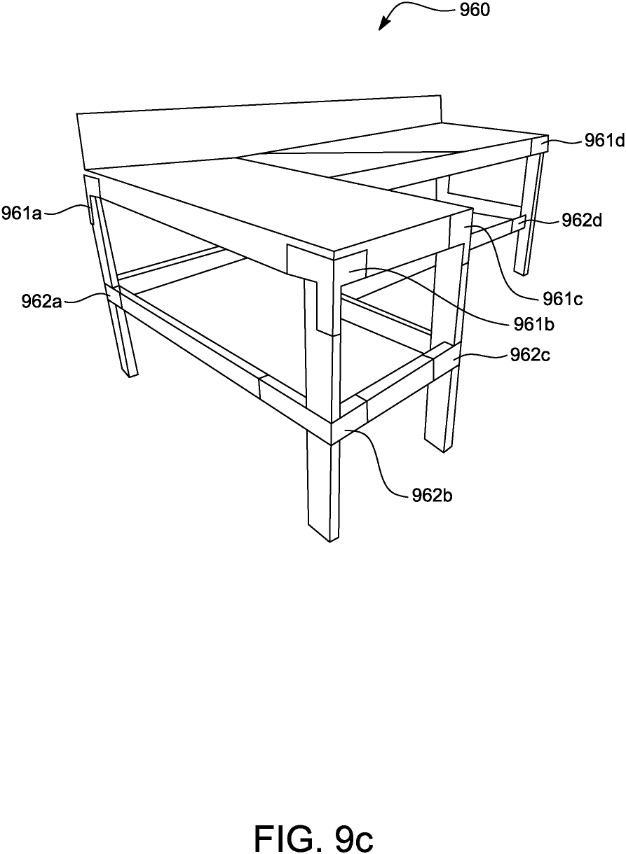

FIGS. 9a-c illustrate use an article of manufacture for providing a various brackets for a self-storage system according to the present invention. FIG. 9a shows a multi-level shelving unit 900 that is constructed using the comer brackets 901a-c of FIG. 3 described above. The set of shelves 902a-d are shown attached to vertical frame members 905a-d to construct the multi-level shelving unit 900. Each of the shelf-layers 902a-d may be on top of or the bottom of the corresponding horizontal frame members 906a-d. When the self-layer 902a are attached on top of the horizontal frame members 906a-d, a shelf is created. The self-layer 902a are attached underneath of the horizontal frame members 906a-d to create a shelf 902c with an enclosed storage container tray. FIG. 9b shows a multi-level worktable 950 made from a plurality of stacked comer bracket 951a-b and a plurality of comer bracket 952a-b. Additional of stacked comer brackets 951a-b and of comer brackets 952a-b are utilized on the comers of the multi-level worktable 950 not visible in FIG. 9c.

Similarly, FIG. 9c shows a L-shaped worktable 960. The L-shaped worktable 960 made from a plurality of stacked comer brackets 961a-d and a plurality of comer bracket 962a-d. Additional of stacked comer brackets 961a-d and of comer brackets 962a-d are utilized on the comers of the L-shaped worktable 960 not visible in FIG. 9c.

Even though particular combinations of features are recited in the present application, these combinations are not intended to limit the disclosure of the invention. In fact, many of these features may be combined in ways not specifically recited in this application. In other words, any of the features mentioned in this application may be included in this new invention in any combination or combinations to allow the functionality required for the desired operations.

No element, act, or instruction used in the present application should be construed as critical or essential to the invention unless explicitly described as such. Further, the phrase “based on” is intended to mean “based, at least in part, on” unless explicitly stated otherwise.

What is claimed is:

1. An article of manufacture for providing brackets for use in a moving and self-storage system according to the present invention, the bracket comprises:
one or more plates coupled together to allow vertical support members to be placed under horizontal support members, creating optimal structural support of the horizontal members in storage objects;
a plurality of through holes in the plates allowing attachment mechanisms to secure the plates to the items used to construct storage object; and
two or more orthogonal plate members extending outward from a bottom edge of the one or more plates, the orthogonal plate members being configured to engage a bottom surface of the items used to construct storage objects when the one or more plates are attached to sides of the items used to construct the storage objects.

2. The bracket according to claim 1, wherein the one or more plates comprise a single broad plate member having two orthogonal plate members coupled to a bottom edge of the single plate member about each end of the single plate member.

3. The bracket according to claim 1, wherein the plurality of through holes are arranged in a plurality of rows of parallel holes spaced across the single broad plate.

4. The bracket according to claim 3, wherein the plurality of through holes are arranged in a plurality of rows of parallel holes spaced across the single broad member and a plurality of rows of parallel holes spaced along the single broad member perpendicular narrow member.

5. The bracket according to claim 1, wherein the one or more plates comprise a single broad member having two orthogonal plate members coupled to a bottom edge of the single broad member about each end of the single plate member and a perpendicular narrow member extending downward from the edge of the single broad member between the two orthogonal plate members.

6. The bracket according to claim 5, wherein the plurality of through holes are arranged in a plurality of rows of parallel holes spaced across the single broad member and a plurality of rows of parallel holes spaced along the single broad member perpendicular narrow member.

7. The bracket according to claim 1, wherein the single broad member and the perpendicular narrow member having a continuous bend running vertically from a top edge of the single broad member to a bottom edge of the perpendicular narrow member about the center forming a corner bracket with identical mirrored sides.

8. The bracket according to claim 5, wherein the plurality of through holes are arranged in a plurality of rows of parallel holes spaced across the single broad member and a plurality of rows of parallel holes spaced along the single broad member perpendicular narrow member, a number of the plurality of through holes are identical on each side of the continuous bend.

9. The bracket according to claim 7, wherein the bracket is made of stainless steel.

10. The bracket according to claim 1, wherein the attachment mechanisms comprise wood screws, nails, and fasteners.
